(19) United States
(12) Patent Application Publication
(10) Pub. No.: US 2005/0135006 A1
(43) Pub. Date: Jun. 23, 2005

(54) Magnetic head

(75) Inventors: Ikuya Tagawa, Kawasaki (JP); Hideyuki Akimoto, Kawasaki (JP); Tomoko Kutsuzawa, Kawasaki (JP); Syuji Nishida, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/063,115

(22) Filed: Feb. 22, 2005

(30) Foreign Application Priority Data
Jan. 7, 2003 (WO) PCT/JP03/00047

(51) Int. Cl. G11B 5/127

(52) U.S. Cl. 360/125

(57) ABSTRACT

A magnetic head increases the magnetic field strength just below a write gap 14 and thereby improves the recording resolution of a medium. To do so, an upper magnetic pole 10 and a lower magnetic pole 12 are disposed facing one another with the write gap 14 in between, with an end surface of the lower magnetic pole 12 being I-shaped and an end surface of the upper magnetic pole being T-shaped due to the upper magnetic pole 10 being formed of a first upper magnetic pole 10a that is disposed facing the lower magnetic pole 12 and is formed in an I shape that is shorter than the lower magnetic pole 12 and a second upper magnetic pole 10b that is joined to the first upper magnetic pole 10a and is formed wider than the first upper magnetic pole 10a.

### TECHNICAL FIELD

The present invention relates to a magnetic head used in a magnetic disc apparatus, a magnetic tape apparatus, or the like, and in particular to a magnetic head where the magnetic poles of the write head have a characteristic shape.

### BACKGROUND ART

A write head, which is the part of a magnetic head used to record information, is constructed with an upper magnetic pole and a lower magnetic pole facing one another with a write gap in between. A coil is wound between the lower magnetic pole and the upper magnetic pole. When a current flows through the coil, the upper magnetic pole and the lower magnetic pole are magnetized and a magnetic field leaks outwards (toward the medium) at the periphery of the write gap. The magnetic field magnetizes the medium, thereby recording information.

The magnetic head floats slightly above the recording surface of the medium due to the medium being rotated and information is recorded on a part of the medium at the write gap. The upper magnetic pole and the lower magnetic pole are provided on opposite sides of the write gap, but in terms of the relationship with the write track on the medium, the upper magnetic pole is located on a side of the write gap that moves away from (in a trailing direction) the part of the medium being recorded by the write gap and the lower magnetic pole is located at a position on the write track that will be passed by the part of the medium that is being recorded.

FIG. 4 shows the construction of the magnetic poles at the front end of a typical conventional write head. In FIG. 4, reference numeral 10 designates the upper magnetic pole, reference numeral 12 designates the lower magnetic pole, and reference numeral 14 designates the write gap. The front end of the upper magnetic pole 10 is formed with a narrow width to increase the area recording density. The narrower the core width CW, the higher the area recording density. Also, to prevent the writing of adjacent tracks or the deleting (“side erasing”) of the adjacent tracks during recording, the lower magnetic pole 12 is trimmed to become the same width as the front end of the upper magnetic pole 10. To form the part of the lower magnetic pole 12 that faces the upper magnetic pole 10 with a narrow width, it is possible to use a method that carries out ion milling on the gap layer and the lower magnetic pole 12 with the upper magnetic pole 10 as a mask after the upper magnetic pole 10 has been formed by a plating process or to use a method that carries out a single plating process using a metal gap. According to this method of manufacturing, the ABS (Air bearing surfaces: surfaces exposed to the floating surface of the magnetic head) of the magnetic poles of the conventional write head are formed as shown inside the circle P so that the end surface of the lower magnetic pole 12 is an inverted T-shape and the end surface of the upper magnetic pole 10 is an I-shape.

However, as the recording density is increased, the track width of the medium becomes narrow and the coercive force Hc of the medium increases. Accordingly, when the core width CW has been narrowed, it is necessary to maintain sufficient write magnetic field strength. To do so, it is necessary to use a material with a high saturation magnetic flux density Bs as the magnetic pole material, to make the gap depth GD more shallow, and to make the flare point height FH lower.

However, if the saturation magnetic flux density Bs of the magnetic pole material reaches a natural upper limit of approximately 2.4 T, magnetic saturation occurs for the magnetic poles so that there is no longer a sudden drop in the gradient of write magnetic field, leading to problems such as deterioration in the recording resolution and an increase in transient noise for the recorded medium. As a result, there is a marked deterioration in the SN ratio of the medium. Accordingly, there is a limit on how high the saturation magnetic flux density Bs of the magnetic pole material can be raised.

The present invention was conceived in order to solve the above problems and it is an object of the present invention to provide a magnetic head that has excellent recording resolution by having a strong magnetic field and large magnetic field gradient at the write gap.

### DISCLOSURE OF THE INVENTION

A magnetic head according to the present invention is characterized by the end surfaces of the upper magnetic pole and the lower magnetic pole of the write head that are disposed facing the recording surface of the medium being formed so that the end surface of the upper magnetic pole is T-shaped and the end surface of the lower magnetic pole is I-shaped. The end surfaces of the write head have a vertically inverted shape compared to the upper magnetic pole 10 and the lower magnetic pole 12 of the conventional magnetic head shown in FIG. 4.

That is, a magnetic head according to the present invention is provided with a write head in which an upper magnetic pole and a lower magnetic pole are disposed facing one another with a write gap in between, wherein an end surface of the lower magnetic pole on a floating surface side is I-shaped, and an end surface of the upper magnetic pole on a floating surface side is T-shaped by having a first upper magnetic pole formed in an I-shape that is shorter than the lower magnetic pole disposed facing the lower magnetic pole and a second upper magnetic pole that is formed wider than the first upper magnetic pole and is joined to the first upper magnetic pole.

In addition, a width of the lower magnetic pole should preferably gradually narrow toward to the floating surface, and a flare point height of the lower magnetic pole should be no greater than three times of a core width.

In addition, the lower magnetic pole may include a first lower magnetic pole whose side surfaces are formed in an I shape and a second lower magnetic pole that is formed wider than the first lower magnetic pole on a lower layer of the first lower magnetic pole and whose end surface is disposed at a position withdrawn from the first lower magnetic pole.

FIG. 7 is a plan view showing how the ABS shape of magnetic pole of the write head are disposed with respect to a write track T and the magnetic field strength distribution at the magnetic pole end surfaces for the conventional magnetic head shown in FIG. 4. In FIG. 7, the darker color represents the strong magnetic writing field.

The magnetic head is driven by a rotary actuator and swings with a range of a specific angle above the medium. Accordingly, the lengthwise direction for the upper magnetic pole 10 and the lower magnetic pole 12 is not limited to being parallel to the track direction of the write track and the magnetic head can be tilted by a maximum of around 10 to 15° to the write track.

In a modern magnetic head, to achieve sufficient write magnetic field strength, the gap depth GD and the flare point height FH are suppressed to around three times the core width CW or below. If the magnetic poles of the write heads become narrow in this way near the floating surface, it becomes easy for magnetic saturation to occur, with magnetic flux leaking across the entire end surfaces of the magnetic poles. This leak magnetic field is susceptible to becoming especially strong at the side surfaces of the upper magnetic pole 10, and appears stronger close to the write gap 14. As a result, the leak magnetic field at the side surfaces of the upper magnetic pole 10 affects the recorded information that has been written on the write track T.

The direction shown by the arrow D in FIG. 7 is the direction in which the medium moves, T1 shows the region that the write gap 14 has passed and in which data has been recorded and T2 shows the region in which data is to be subsequently recorded. The leak magnetic field (part E in FIG. 7) at the side surfaces of the upper magnetic pole 10 described above is positioned on downstream side of the write gap 14, so that the information recorded on the write track T by the write gap 14 part is subjected to the effects of the leak magnetic field at the side surfaces of the upper magnetic pole 10 immediately after recording. It should be noted that the leak magnetic field F that appears at the side of the lower magnetic pole 12 in FIG. 7 also affects the recorded information on adjacent write tracks.

FIG. 8 is a graph of the magnetic field strength of the conventional magnetic head described above with the write track (down track) direction as the horizontal axis (a plot of the magnetic field strength along the center of the core width). The zero point on the horizontal axis corresponds to a center position of the write gap 14. In FIG. 8, H0 shows the dynamic coercive force of the medium and Hc shows the normal (coercive) force of the medium. The magnetic field strength that is required for recording information (magnetic transition) is the dynamic (coercive) force H0 of the medium, and information is recorded at the part shown by the region A in the graph. Next, the medium moves toward the upper magnetic pole and is subjected by the effect of the leak magnetic field of the upper magnetic pole. The area B shown in the graph is the area of the medium affected by the leak magnetic pole. When the effect of the leak magnetic field is at least as high as the normal coercive force Hc of the medium, the information recorded on the medium is subjected to a disturbing effect, which causes deterioration in the signal to noise ratio (SNm) of the medium. In the illustrated example, the effect of the leak magnetic field (shown by the area B) is higher than the normal coercive force Hc of the medium, so that the leak magnetic field causes deterioration in the SN ratio.

On the other hand, FIG. 5 shows the magnetic field strength distribution at the ABS (the magnetic pole end surfaces) of the magnetic head according to the present invention. The magnetic head according to the present invention is formed with the end surfaces having a vertically inverted shape compared to the upper magnetic pole and the lower magnetic pole of the conventional magnetic head. Accordingly, magnetic saturation that occurred for the upper magnetic pole 10 of the conventional magnetic head occurs at the lower magnetic pole 12 and it is difficult for magnetic saturation to occur at the upper magnetic pole 10. As a result, the leak magnetic field at the magnetic pole end surfaces of the write head is generated at the lower magnetic pole 12 and is hardly a problem at the upper magnetic pole 10.

FIG. 6 is a graph showing the magnetic field strength (the downtrack profile) at the magnetic pole end surfaces of the magnetic head shown in FIG. 5. This magnetic head is characterized by the magnetic field strength suddenly attenuating to the normal antimagnetic force Hc of the medium or below on the upper magnetic pole side of the position A at which information is recorded onto the medium. This shows that the period during which a magnetic field disturbs the information recorded on the medium is extremely short, so that compared to when the conventional magnetic head is used, the signal to noise ratio (SNm) of the medium can be improved.

It should be noted that as shown in FIGS. 5 and 6, with the magnetic head according to the present invention, the leak magnetic field is at least as high as the normal coercive force Hc on the upstream side (the region T2 in FIG. 5) of the write gap 14, but since the recording of information is carried out further downstream, the leak magnetic field of the lower magnetic pole 12 does not adversely affect the signal to noise ratio (SNm).

### BRIEF DESCRIPTION OF THE DRAWINGS

FIG. 1 is a perspective view showing the construction of a write head part of a magnetic head according to the present invention;

FIG. 2 is a perspective view showing another construction of a magnetic head according to the present invention;

FIG. 3 is a perspective view showing the construction of a comparative example of a magnetic head;

FIG. 4 is a perspective view showing the construction of a conventional magnetic head;

FIG. 5 is a diagram showing the magnetic field strength distribution at end surfaces of magnetic poles of the magnetic head according to the present invention;

FIG. 6 is a graph showing a downtrack direction profile for the magnetic field strength of the magnetic head according to the present invention;

FIG. 7 is a diagram showing the magnetic field strength distribution at end surfaces of magnetic poles of the conventional magnetic head;

FIG. 8 is a graph showing a downtrack direction profile for the magnetic field strength of the conventional magnetic head;

FIG. 9 is a diagram showing the magnetic field strength distribution at end surfaces of magnetic poles of the comparative example of a magnetic head shown in FIG. 3;

FIGS. 10A and 10B are diagrams useful in explaining recording magnetized states for the magnetic head according to the present invention; and

FIGS. 11A and 11B are diagrams useful in explaining recording magnetized states for the conventional magnetic head.

### BEST MODE FOR CARRYING OUT THE INVENTION

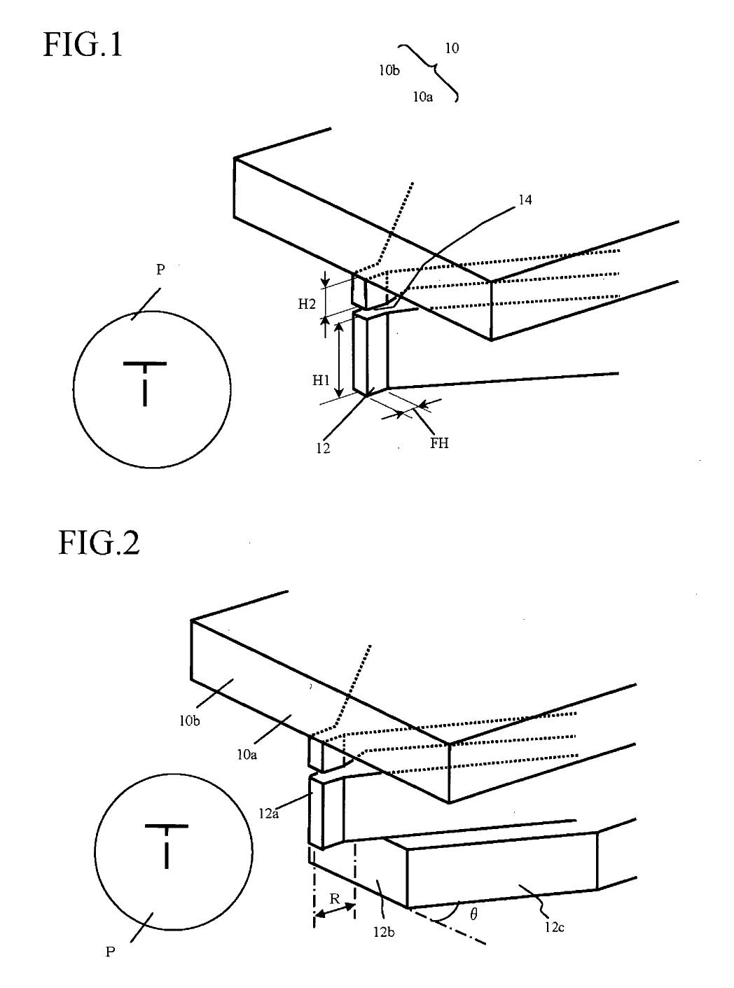

FIG. 1 shows the construction of an embodiment of a magnetic head according to the present invention. In FIG. 1, the construction of a write head that is characteristic to the present invention is shown. In a magnetic head according to the present invention, the write head is formed of an upper magnetic pole 10 whose end surface on the floating surface side is T-shaped and a lower magnetic pole 12 whose end surface is I-shaped (rectangular) and which is disposed facing the upper magnetic pole 10 with a write gap 14 in between.

The upper magnetic pole 10 is composed of a first upper magnetic pole 10a and a second upper magnetic pole 10b that is formed of a magnetic film that is wide in a direction perpendicular to the first upper magnetic pole 10a. The upper magnetic pole 10 can be formed by forming the first upper magnetic pole 10a whose end surface is I-shaped (rectangular) and then joining a wide magnetic film above the end surface of the first upper magnetic pole 10a. By doing so, the second upper magnetic pole 10b is formed at an opposite end surface of the first upper magnetic pole 10a to the write gap 14.

It should be noted that in the magnetic head according to the present embodiment, the length H2 of the first upper magnetic pole 10a should preferably be shorter than the length H1 of the I-shaped end surface part of the lower magnetic pole 12. Also, the length H2 of the end surface of the first upper magnetic pole 10a should preferably be formed longer than the gap length of the write gap 14. The length H1 (thickness) of the lower magnetic pole 12 is not subject to any particular limitations, but the length H2 of the first upper magnetic pole 10a should preferably be set shorter than the length H1 of the lower magnetic pole 12 (that is, H2<H1).

In addition, in the magnetic head according to the present embodiment, the flare point height FH of the first upper magnetic pole 10a and the lower magnetic pole 12 should preferably be set lower than the flare point height FH of the conventional magnetic head shown in FIG. 4 at three times the core width or below. The width (in a plan view) of the lower magnetic pole 12 is provided so as to gradually narrow toward the floating surface as tapered surfaces on both sides of the lower magnetic pole 12 so that the lower magnetic pole 12 has a pointed shape that narrows toward the front end of the core. It should be noted that the first upper magnetic pole 10a is also formed with a pointed shape that narrows toward the front end of the core, so that the first upper magnetic pole 10a is formed so as to narrow toward the front end in the same way as the lower magnetic pole 12.

In FIG. 1, the circle P shows a representation of the ABS shapes of the upper magnetic pole 10 and the lower magnetic pole 12. In the magnetic head according to the present embodiment the upper magnetic pole 10 is T-shaped and the lower magnetic pole 12 is I-shaped, so that the ABS shape have a vertically inverted compared to the upper magnetic pole and the lower magnetic pole of the conventional magnetic head shown in the circle P in FIG. 4.

FIG. 2 shows the construction of another embodiment of a magnetic head according to the present invention. The magnetic head according to the present embodiment is characterized by a second lower magnetic pole 12b that is wider than a first lower magnetic pole 12a being provided on a lower layer of the first lower magnetic pole 12a whose end surface is formed in an I shape, the end surface of the second lower magnetic pole 12b being at a position (a length R) withdrawn from the first lower magnetic pole 12a. It should be noted that side surfaces 12c of the second lower magnetic pole 12b should preferably be formed as tapered surfaces (with an angle θ) that gradually narrow toward the floating surface.

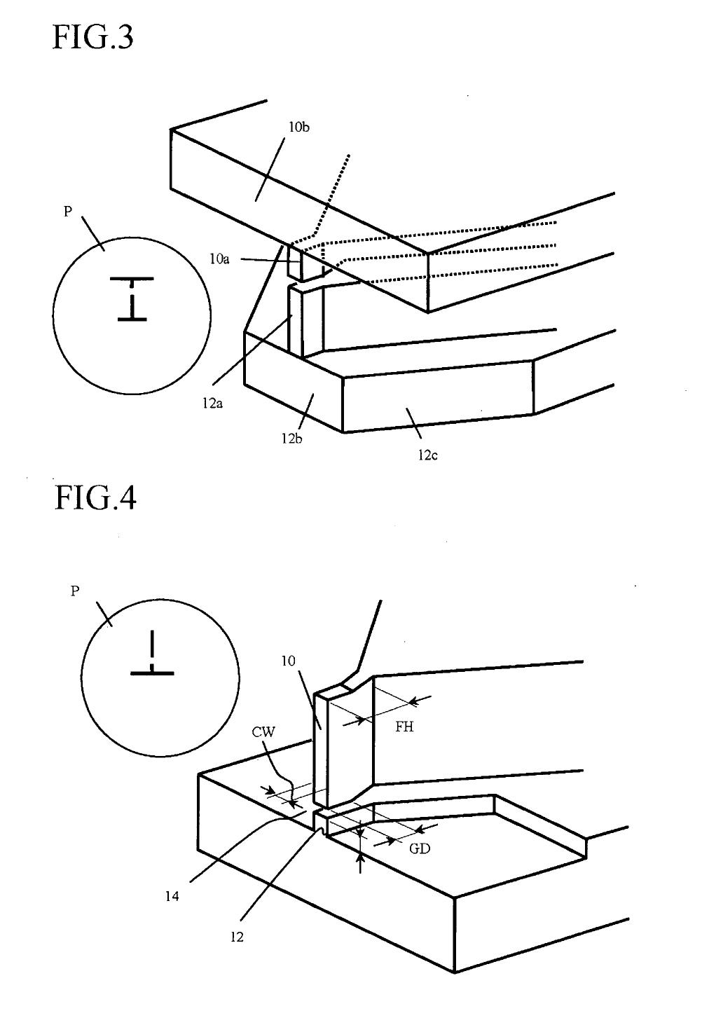

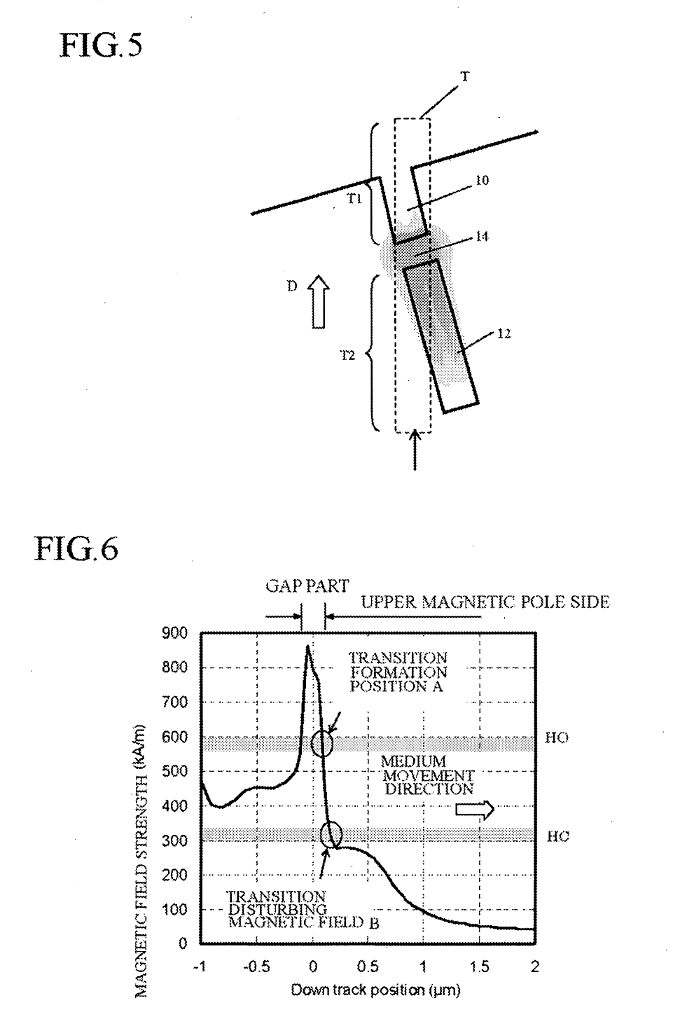

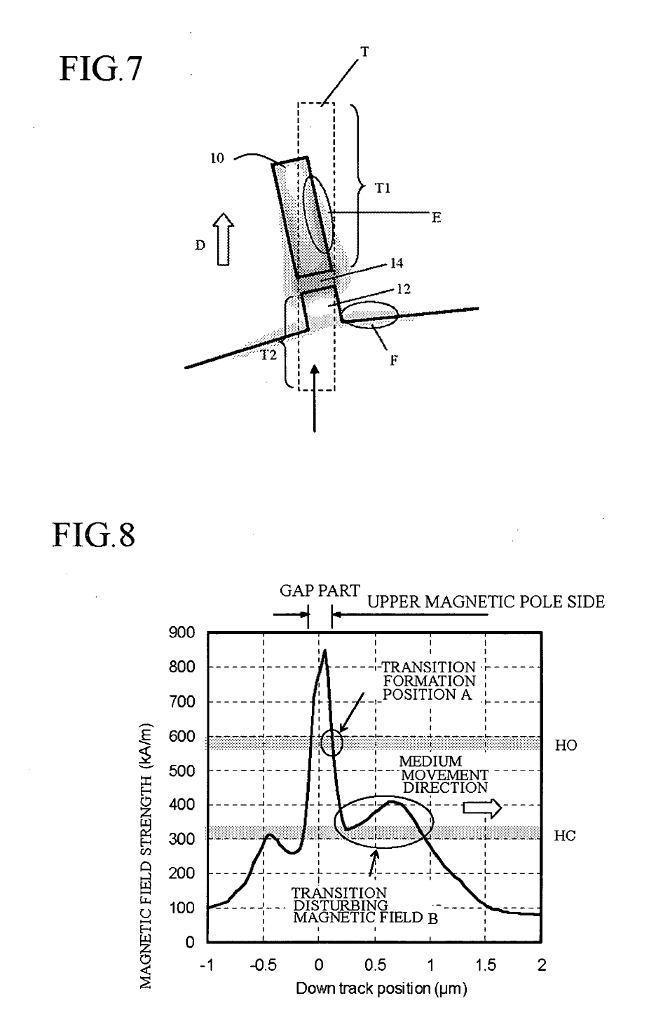

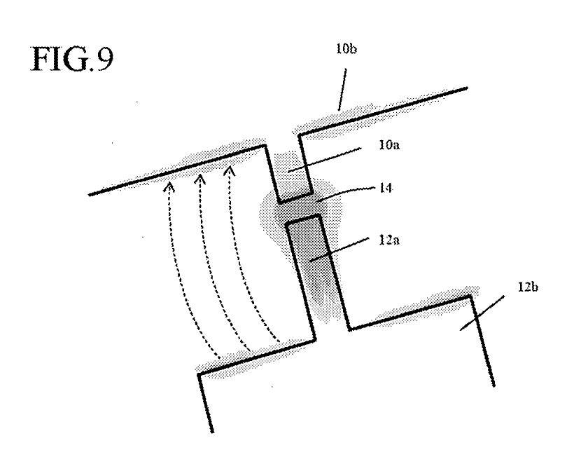

FIG. 3 shows, as a comparative example of a magnetic head provided with a second lower magnetic pole 12b, an example of a magnetic head where the end surface position of the second lower magnetic pole 12b formed so as to be flush with the end surface position of the first lower magnetic pole 12a. FIG. 9 shows the magnetic field strength distribution at the end surfaces of the magnetic poles for the magnetic head of this comparative example. As shown in FIG. 9, if the wide second lower magnetic pole 12b is exposed to the floating surface after the first lower magnetic pole 12a, even though magnetic saturation does not occur for the magnetic poles, the magnetic flux that should fundamentally be concentrated in the write gap 14 flow directly from the second lower magnetic pole 12b that is formed widely to the second upper magnetic pole 10b that is also formed widely. This means that an unnecessary leak magnetic field is produced, which causes problems such as side erasing. In the embodiment shown in FIG. 2, the end surface of the second lower magnetic pole 12b is positioned further back from the end surface of the first lower magnetic pole 12a and the side surfaces 12c of the second lower magnetic pole 12b are formed as tapered surfaces, so that the magnetic flux can be prevented from leaking from the second lower magnetic pole 12b to the second upper magnetic pole 10b, magnetic flux can be concentrated in the write gap 14, and the signal to noise ratio (SNm) of the medium can be improved.

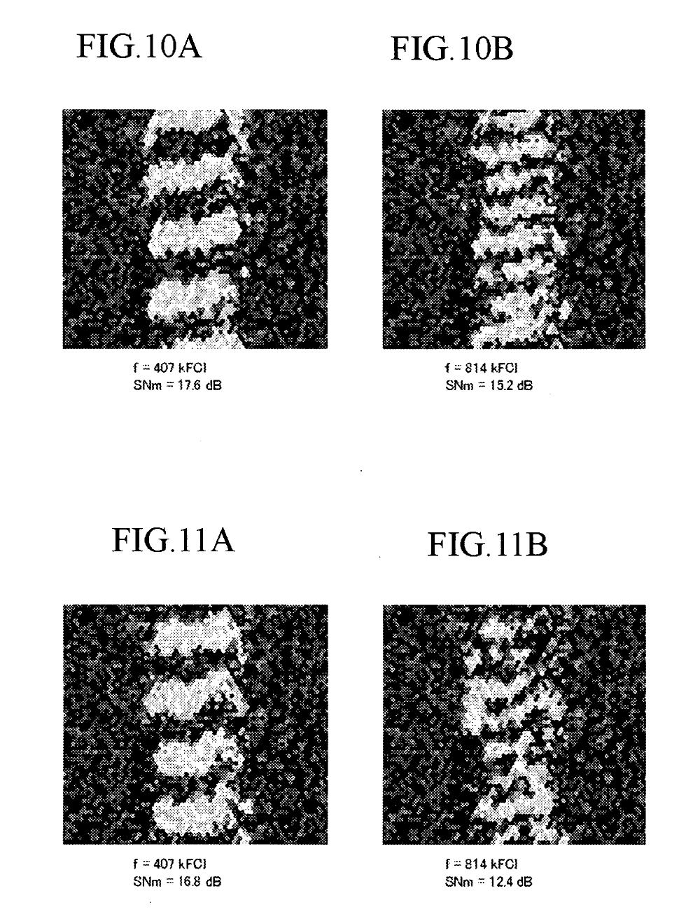

FIGS. 10A, 10B and FIGS. 11A, 11B show the result of comparing the recording magnetized states of the medium for the magnetic head according to the present invention to a magnetic head of the conventional construction in a micromagnetic simulation. FIG. 10A and FIG. 11A show recording magnetized states of the medium when the linear recording density f=407 kFCI while FIG. 10B and FIG. 11B show the recording magnetized states of the medium when the linear recording density f=814 kFCI. It should be noted that the simulation conditions were as follows.
Anisotropic magnetic field of the medium Hk=1200 kA/m
Dynamic antimagnetic force H0=590 kA/m
Saturation magnetism Ms=300 kA/m
Particle diameter=9 nm
Film thickness=11 nm
Track width=150 nm
Gap length=100 nm
Magnetic spacing=15 nm
Maximum magnetic strength=780 kA/m
Skew angle=10 deg.

The medium SNm was calculated from the simulation results by producing twenty particle anisotropic orientation states generating random numbers and setting such states as the initial state.

The results for the signal to noise ratio (SNm) of the medium were as follows Magnetic head according to the present invention: when f=407 kFCI, SNm=17.6 dB and when f=814 kFCI, SNm=15.2 dB.

Magnetic head of the conventional construction: when f=407 kFCI, SNm=16.8 dB and when f=814 kFCI, SNm=12.4 dB As shown in FIG. 11B, with the magnetic head of the conventional construction, during high density recording where f=814 kFCI, a phenomenon where bits are partially connected to each other is observed and the medium SNm is poor.

On the other hand, with the magnetic head according to the present invention, as shown in FIGS. 10A and 10B, the bits are recorded clearly, and in particular an improvement of close to 3 dB was observed when f=814 kFCI.

With the magnetic head according to the present invention, it is possible to raise the magnetic field strength directly below the write gap 14 and as shown in FIG. 6 it is possible to produce a sudden drop in the magnetic field distribution in a periphery of the write gap 14, so that the magnetic resolution of the medium can be effectively improved. By doing so, it is possible to provide a magnetic head with a high manufacturing yield.

1. A magnetic head provided with a write head in which an upper magnetic pole and a lower magnetic pole are disposed facing one another with a write gap in between,
wherein an end surface of the lower magnetic pole on a Air bearing surface is I-shaped, and
an end surface of the upper magnetic pole on a Air bearing surface is T-shaped by having a first upper magnetic pole formed in an I-shape that is shorter than the lower magnetic pole disposed facing the lower magnetic pole and a second upper magnetic pole that is formed wider than the first upper magnetic pole and is joined to the first upper magnetic pole.

2. A magnetic head according to claim 1, wherein a width of the lower magnetic pole gradually narrows toward a side close to the floating surface, and a flare point height of the lower magnetic pole is no greater than three times a core width.

3. A magnetic head according to claim 1, wherein a length of the first upper magnetic pole is shorter than a length of the lower magnetic pole that is formed in an I shape.

4. A magnetic head according to claim 3, wherein a length of the first upper magnetic pole is shorter than a gap length of the write gap.

5. A magnetic head according to claim 3, wherein a length of the end surface of the lower magnetic pole that is I shaped is longer than a core width.

6. A magnetic head according to claim 1, wherein the lower magnetic pole comprises:
a first lower magnetic pole whose end surface is formed in an I shape; and
a second lower magnetic pole that is formed wider than the first lower magnetic pole on a lower layer of the first lower magnetic pole and whose end surface is disposed at a position withdrawn from the first lower magnetic pole.

7. A magnetic head according to claim 6, wherein a width of the second lower magnetic pole gradually narrows toward a side close to the Air bearing surface.
